(19) United States
(12) Patent Application Publication
(10) Pub. No.: US 2013/0176905 A1
(43) Pub. Date: Jul. 11, 2013

(54) NODE ARBITRATED MEDIA ACCESS CONTROL PROTOCOL FOR AD HOC BROADCAST NETWORKS CARRYING EPHEMERAL INFORMATION

(71) Applicant: L-3 Communications - ASIT, Linthicum Heights, MD (US)

(72) Inventor: James D. Haverty, Boxborough, MA (US)

(73) Assignee: L-3 COMMUNICATIONS - ASIT, Linthicum Heights, MD (US)

(21) Appl. No.: 13/783,953

(22) Filed: Mar. 4, 2013

Related U.S. Application Data
(62) Division of application No. 12/377,583, filed on Feb. 13, 2009.
(60) Provisional application No. 60/822,443, filed on Aug. 15, 2006.

(51) Int. Cl. H04W 84/18

(52) U.S. Cl. CPC H04W 84/18
USPC 370/255

(57) ABSTRACT

Techniques for organizing nodes of an ad hoc broadcast network into sets and employing the sets to arbitrate access by the nodes to a shared communications medium. Each node has a copy of a signal library and the node indicates its membership in the set by associating itself with a signal in the library. In one application, the signals are ranked, the set is a queue, and the node's position in the queue is indicated by the rank of the signal associated with the node. Each node has rules for selecting the next signal. The hidden terminal problem is solved by having each node broadcast its tone and all of the other tones it has heard. The techniques are particularly useful for the broadcast of ephemeral information by the nodes.

### CROSS-REFERENCE TO RELATED APPLICATIONS

This application is a divisional application of U.S. patent application Ser. No. 12/377,583, filed on Feb. 13, 2009, which is a U.S. National Stage application of PCT/US2007/075972, filed Aug. 15, 2007, which claims priority from U.S. provisional patent application 60/822,443, filed Aug. 15, 2006, entitled Node Arbitrated Media Access Control.

### FIELD OF THE INVENTION

A need exists for an efficient communication protocol for the distribution of ephemeral information among nodes belonging to an ad hoc network. Ephemeral information is information that is highly perishable: it is valuable if promptly provided to its destination, but has no value if it is delayed. An example of ephemeral information is position information that specifies the current position of a moving object. An ad hoc network is a network which nodes can enter or leave without registering with a central controller. A broadcast network is one in which the medium used to transfer information among nodes is a medium such as RF where the signal levels cannot be controlled and therefore it is a) difficult in general to detect a collision or more precisely determine whether energy is due to the node's own transmission versus those of other nodes and b) the medium may permit the existence of “hidden terminals”, i.e., situations in which two nodes can hear each other but a third may be able to hear only one or the other and therefore may not properly detect a collision condition. In the following, such media will be termed open media. Broadcast ad hoc networks that efficiently distribute ephemeral information among the nodes of the network are particularly suited to networks of moving nodes that have sensor systems and that share information from the sensors among the nodes such that any single node uses the sensor information from the other nodes to achieve greater performance. Advantages of such networks are increased time to respond (e.g., look-ahead) or the ability to make a decision based on information received from sensors in other nodes of the network.

Difficulties in the design of such ad hoc networks include the following:
Such networks often operate over live radio links where communications are not guaranteed.
The information from the sensors is ephemeral to the degree that it is neither efficient nor timely to use error checking and retransmission request methods to guarantee the integrity of the information.
Moving nodes must be able to join the network when they are within range of transmissions from other nodes of the network and leave when they are no longer in range.

This last requirement makes it extremely difficult to use conventional point to point (PTP) communications in the network, as any given node would be required to discover and then establish and manage a PTP connection with each and every other node that it senses. Apart from the degree of complexity, such an implementation might easily overtax the available communications bandwidth because the number of PTP links increases geometrically as the number of nodes increases.

The network cannot rely on some single fixed controller nor can any of the nodes be dynamically designated as the “arbiter” that allocates communications channels and/or coordinates timing without introducing serious complexities for passing ownership, as the arbiter may leave the network at any time. Another serious shortcoming is that such a network is only as robust as is the connection to the arbiter. If the arbitrating node fails (e.g., enters a radio link fade) or dies altogether all other nodes are impacted up to including a total network failure. Finally, the problem may be further complicated by nature of the access media itself For example it may be the case that the sensing network is using an already occupied communication band and must therefore dynamically work around interference from within the communication band.

Because the information provided by the sensors is ephemeral, broad information transport integrity is not required. Instead the sensor network can employ a broadcast paradigm in which each node rapidly and repeatedly broadcasts information to the other nodes without waiting for confirmations from the other nodes. While such broadcasts of information would, as a matter of course, employ error detection and/or forward error correction to prevent erroneous data from being received and therefore misinterpreted, the ephemeral nature of the information means that it is not required that a specific instance of the information be received at all. The network can be more forgiving as information that does not get through at a given point in time rapidly becomes stale and is supplanted by fresher information. The broadcast paradigm further permits the nodes to seamlessly enter and exit the network as proximity dictates because the relevance of information broadcast by any node in relation to some other node is generally inversely proportional to the distance between them.

Given the clear advantages of an ad hoc network that employs a broadcast paradigm for communicating ephemeral information among network nodes, the issue becomes how to provide the nodes with the information they need to seamlessly and dynamically arbitrate amongst themselves to gain broadcast access to some shared medium without requiring each node to expressly sense that other nodes have joined or left the network.

2. Description of Related Art

Prior art techniques for arbitrating communications media access are numerous and well established. Furthermore, techniques for nodes to communicate without the benefit of a central controller as well as the ability for multiple nodes to join or leave a network are also well documented (e.g., carrier sense multiple access/collision detect (CSMA/CD) used in Ethernet based networks; carrier sense multiple access/collision avoidance (CSMA/CA) used in Wireless LANs (Wi-Fi) specified in such standards as IEEE 802.11; or slotted Aloha used in cellular network access). Further still these techniques provide for broadcast methods that allow a single node to communicate information to all of the other nodes simultaneously. However, these techniques all have shortcomings when used to make ad hoc broadcast networks that carry ephemeral information.

CSMA/CD

The CSMA/CD model solves the problem of controlling transmit access by nodes to the medium by means of collision detection with random back-off and retransmit. Essentially, a given node achieves transmit access to the medium by first listening for a transmission by any other node in the media (carrier sense) and if detected refrains from transmitting until such time that the media becomes idle. Once the medium is idle, the given node will transmit a burst of information that is expressly addressed to another node on the network. Appended to all bursts are CRCs. While transmitting a burst, a node will also simultaneously listen for what is known in the art as a collision wherein another node begins transmission simultaneously. When a transmitting node detects a collision, the transmitting node generates a jamming signal to corrupt the other node's transmission. The effect of this is that each node detects that its transmission has been corrupted. On detection, the node backs off a small random amount of time and attempts retransmission by listening for an idle media and transmitting. The other node, which has backed off a different amount of time, will retransmit in the same fashion. The CSMA/CD model presumes a closed environment such as wired LAN where the signals can be expected to beat some controlled levels. This makes it possible to achieve the collision detection mechanism so important to the model. However, the need for a closed environment also precludes its use with open media.

CSMA/CA

The CSMA/CA model is used in open media such as radio. In the model, the nodes have addresses and a message includes the address of the node for which the message was intended. To transmit a message to a node, the transmitting node sends messages to all of the nodes on the network to keep them off the network while the transmitting node is transmitting. After the transmitting node has sent the message, it waits for an acknowledgment from the receiving node. The acknowledgment is sent in the manner just described. Because nodes are sending messages to and waiting for messages from other nodes in the network, each node must have a complete list of the addresses of all of the other nodes in the network.

Slotted Aloha

In cellular telephony, the slotted Aloha model is used for arbitrating access by a single resource such as a cellular handset (terminal) to the channels managed by a cellular tower (access point). In this model, the access point broadcasts a timing signal that allows the terminal to determine the timing of a slot in which the terminal can send a request for access to the access point. Once the terminal gains access to the access point, the access point can assign the terminal to a channel in which it does not interfere with (is mutually exclusive to) all other terminals, through a variety of schemes such as time, frequency or code division multiplexing. However before gaining access, it is possible that a terminal will mutually co-interfere (collide) with another terminal when attempting to gain access.

Slotted Aloha solves this problem by having the access point explicitly acknowledge an access attempt that it has received from a terminal and then direct the terminal to a reserved resource (e.g., channel) where it is no longer in conflict If access attempts by one or more terminals collide in a given slot, as evidenced by the fact that more than one (to perhaps all) does (do) not receive a response from the access point, then each will back off for a random time as described above and again attempt access—a terminal repeats this process until it ultimately gains access to the access point. It is well understood in the art that using slotted Aloha, where the access attempts can only occur in the slots, significantly improves the efficiency of the access performance in comparison with non-slotted Aloha. Of course, terminals which have access to the access point can only communicate with each other via the access point.

A version of slotted Aloha which does not require an access point and consequently can be used for ad hoc networks is described in the paper, F. Borgonovo, A. Capone, M. Cesana, L. Fratta, “RR-ALOHA, a Reliable R-ALOHA broadcast channel for ad-hoc inter-vehicle communication networks”, Med-Hoc-Net 2002, Baia Chia, Italy. In this version, the network defines a frame in which there are number of slots during which network nodes can broadcast. Each node of which currently belongs to the ad hoc network has a slot in the frame and that slot serves as a basic channel for the node. Each node maintains a list of the slots which are being used and those which are free. Each node broadcasts its version of the list to all of the other nodes. A node which wishes to join the network listens to the broadcast lists, selects a slot which is free in all of the lists which it receives, and begins using the slot as its basic channel. The slot remains reserved for messages from the node as long as the other nodes can receive the list of slots which the node broadcasts to the other nodes. Because a node's slot is reserved, there is no need in RR-ALOHA to arbitrate among nodes for access to the broadcast medium. On the other hand, each node must wait for its slot to broadcast even though another node is not using its slot. Further, the fact that the number of slots in the frame is fixed means that once all the slots are occupied, no new node can join the network; additionally, that fact and that each slot requires a fixed portion of the network's bandwidth means that RR-ALOHA wastes network bandwidth. There must be enough slots in the frame to accommodate the greatest possible number of nodes in the network, but nodes that already have slots cannot use these available slots. Finally, if a node that has a slot does not use it, no other node can use it.

As is apparent from the foregoing, none of the above models is well suited for an ad hoc network that employs an open broadcast medium to share ephemeral information among the nodes of the network. The CSMA//CD model simply does not work with open media. The CSMA/CA model is not viable in networks that employ the broadcast paradigm because each node must have a PTP connection with all other nodes in the network. The slotted Aloha model requires a central controller (arbiter), uses a (many to one) PTP paradigm, and does not permit terminals a that are in relative proximity to share information directly. RR-ALOHA solves many of the foregoing problems, but requires that each node wait for its slot to broadcast, may run out of slots for nodes joining the network, and does not efficiently use the bandwidth of its medium and

What is needed is techniques for making ad hoc networks that employ the broadcast paradigm, work in an open medium, handle any number of nodes, maximize the speed with which a node which actually has a message to broadcast can gain access to the medium, and do not waste bandwidth. It is an object of the present invention to provide such techniques.

### SUMMARY OF THE INVENTION

The object is attained in one aspect by providing techniques by which nodes in ad hoc broadcast networks can use priorities to determine which node has the right to broadcast in a particular interval of time. The nodes of the network use a single source of time information to determine the particular interval of time. In these techniques, each node of the ad hoc broadcast network receive node priority messages which are broadcast by nodes of the network which have payload messages to broadcast during a first interval of time that is determined using the single source of time information. A node which has a payload message to broadcast determines from the node priority messages whether the node has priority over other nodes with payload messages with regard to broadcasting the node's payload message in the medium. If the node does have priority, it broadcasts the node's payload message during a second interval of time that the node determines using the single source of time information.

The object is attained in another aspect by a method used by a node in an ad hoc broadcast network of joining a set of nodes in the network. The nodes of the network have access to a single source of time information. In the method, each node in the set broadcasts signals belonging to a library of signals in a first interval of time and the joining node listens to the signals broadcast by the nodes. The joining node then selects a signal from the library which is not in the set of broadcast signals. In a second interval of time, the joining node broadcasts the selected signal and detects signals broadcast individually by the other nodes. In the next first interval of time, the joining node broadcasts the selected signal and the detected signals.

The object is attained in a further aspect by a method used by nodes in an ad hoc broadcast network of arbitrating access to a communications medium which is shared among the nodes. The nodes of the network have access to a single source of time information and are associated with signals belonging to a library of ranked signals that is known to each of the nodes. In a first interval of time, each node which wishes to access the communications network receives a set of the signals associated with the nodes wishing to access the communications network. The node determines the rank of the signal with which the node is associated in the set of signals. If the associated signal has the highest ranking, the node accesses the shared communications medium during a second interval of time; if the associated signal does not have the highest ranking, the node does not access the shared communication medium during the second interval of time.

The object is attained in an additional aspect by a frame in a communications medium. The frame is employed by nodes in an ad hoc broadcast network. The nodes share the communications medium, have access to a single source of time information, and use the frame to arbitrate for access to the communications medium to broadcast a payload message. The frame is made up of three intervals of time which each node determines using the single source of time information. During the first interval of time each node broadcasts a signal from a library of signals. The broadcast signal is associated with the node and the signals are ranked in the library. During the first interval of time, each node also receives signals broadcast by other nodes of the network. During the second interval of time, each node broadcasts an indication of all of the signals received in the node and receives indications of the signals received in the other nodes and determines a priority relationship between the signal associated with the node and the signals indicated by the received indications. During the third interval of time, the node whose signal has the highest rank in the broadcast indication of all of the signals broadcasts its payload message.

The object is attained in still another aspect by a method of forming a queue of nodes belonging to an ad-hoc broadcast network. The queue has a head node which performs an action and each node has a copy of a library of ranked signals. All of the nodes have access to a single source of time information and nodes in the queue are associated with signals in the library. The steps of the method are performed in each node of the queue during repeated first intervals of time which each node determines using the single source of time information. The steps include for a node which is in the queue, broadcasting signals associated with the nodes in the queue during each repeated first interval of time; for a node which is joining the queue, listening to the signals broadcast in a current first interval of time to determine a signal which is not currently associated with a node in the queue and associating that signal with the joining node; in a node which is in the queue, listening to the signals broadcast in the current repeated first interval of time to determine whether the node is the head node, the head node being the node whose associated signal has the highest rank in the broadcast signals; if the node is the head node, performing the action in a repeated second interval of time which each node determines using the single source of time information and ending the association between the node and the highest ranked signal; and otherwise associating the node with a higher ranked signal in the library before broadcasting the signals associated with the nodes during the next repeated first interval of time.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1—Abstract Protocol Structure and Mechanics

FIG. 2—Example of Mechanics for Detecting other Nodes and Minimizing Mutual Failure to Detect

FIG. 3—Hidden Terminal Problem Abstraction and Example

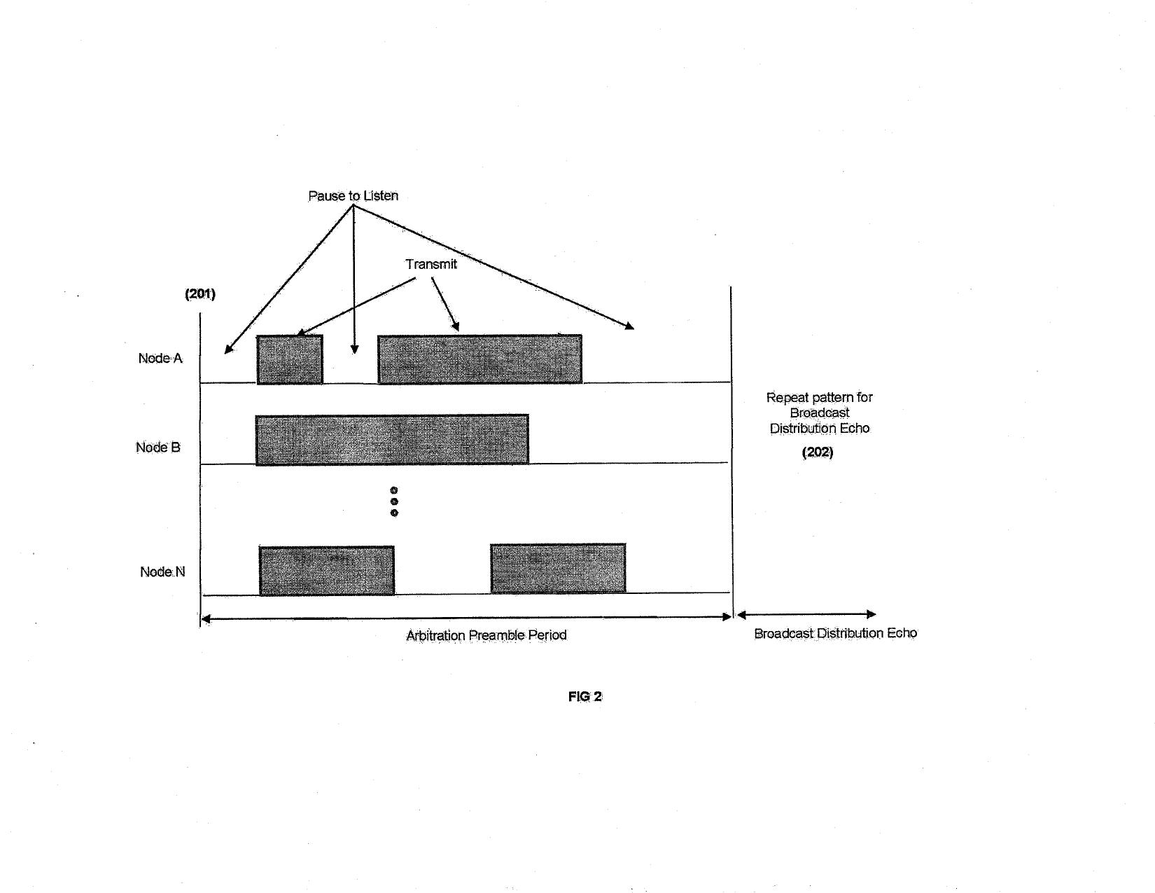

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

### Overview of the Yak Access Protocol

A protocol which embodies the invention is termed herein the Yak Access Protocol (YAP). The YAP enables an ad hoc network made up of an indefinite number of communications nodes to efficiently share ephemeral information over an open medium. YAP solves the problem of arbitrating access by the nodes to the open medium by using a common timing source, including but not limited to GPS, that is shared by all of the members of the network and then dividing the transmission times up into to some number of absolute time epochs called frames. Each frame has two parts, one in which the nodes that have messages to send arbitrate for access to the open medium and another in which the node that wins the arbitration broadcasts its message. Each of the arbitrating nodes has a priority for that arbitration relative to the other nodes and the node with the highest priority for that arbitration wins the arbitration. The method used by the nodes to determine their relative priorities for each arbitration ensures that all nodes gain rapid access to the medium and that nodes joining the network are treated like nodes already in the network. As long as there are nodes arbitrating for access to the medium, most frames will carry a message.

The following summarizes the advantages of the YAP.
Channel Independent—Nothing in YAP requires specific kinds of communication channels or modulations.
Minimum Transceiver Complexity—Because each node in a YAP network operates in a half-duplex mode, transceiver complexity is minimized
Specialized for the communication of ephemeral Information—Because the information carried in YAP is ephemeral, YAP does not make provisions for guaranteed transport of information. This simplifies the operation of the protocol and allows for an indefinite number of nodes to communicate. YAP's arbitration scheme minimizes collisions between nodes and provides for rapid repeated transmission of messages.
Insensitive to Packet Loss—YAP is designed to operate on radio communication links where packet loss is a common occurrence—for example due to fading, interference, access collisions or marginal proximity. Therefore the information carried in any given frame is self contained and is constantly repeated at the maximum rate allowed by the medium until the information is updated.
Linearly and Seamlessly Scalable—The protocol scales linearly and gracefully with the number of nodes and enables the nodes to seamlessly interact in some operational area. Each node can broadcast to all of the other nodes and nodes can enter and exit the network.
Secondary Medium Access Control—YAP can be used to act as a Medium Access Control (MAC) agent for secondary communications such a voice or data. A network node can use the YAP protocol to broadcast the particulars regarding the specific information on which the node is operating such as frequency channels, time slots and the like to other nodes in the network.
Hidden Terminal Arbitration—solves the problem of preventing hidden terminals (nodes) from interfering at a common node.

Details of the Protocol Structure

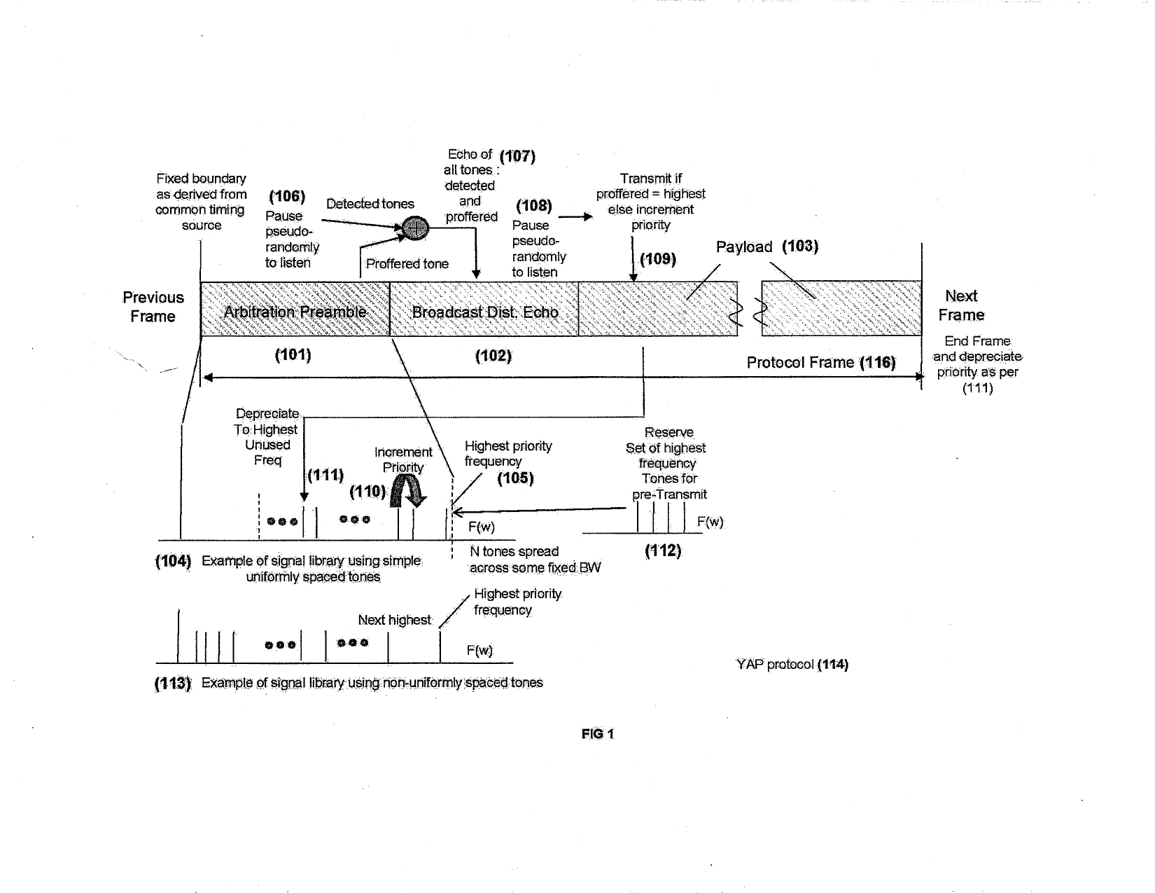

Overview of the Protocol'S Structure: FIG. 1

The structure of the YAP protocol is shown in FIG. 1. Protocol (114) consists of a series of fixed length frames (116), each having an access arbitration preamble portion (101), a broadcast distribution echo portion (102), and a payload transmission portion (103). Because the nodes of the YAP network share a single timing source, each node can locate the frame and its portions in the medium. Further, as long as all of the nodes use an identical randomization method, the start of the frame may be randomized to thwart attempts at jamming Similarly, the frame may be timed to work around existing signaling from other sources in the medium being used by the YAP. Here, too, each of the nodes must have the information necessary for the work around. An example here is sharing a band used by a cellular telephone system. In such a case, the timing of the portions of the YAP frame may be adjusted to avoid interference from the cellular telephone system. The lengths of the frame and its portions may vary in different versions of the YAP protocol, with the lengths for a particular version being driven by the particular circumstances in which a version is used. For example the particular spectrum, the required transfer and update rates, and the expected and maximum number of nodes will all influence the choice of the duration of each of the portion within the frame. The only requirement is that all nodes in a given YAP network agree on both the frame's timing and the frame's structure (i.e., when a frame starts and how long each of the frame's subcomponents lasts).

Arbitration preamble (101) is a portion of the frame in which each node which wishes to send a message transmits a signal which is associated with the node for this frame as a “bid” for access. The node has selected the signal which it uses in the frame from a predetermined signal library which is known to all of the nodes. The mechanism by which a node selects its signal in a given frame will be explained in detail later.

Each of the signals in the set of signals making up the library has a finite bandwidth and is orthogonal to the other signals in the set. Any mutually orthogonal set of signals may be employed. Example include sets of tones (e.g., OFDM—orthogonal frequency division multiplexing) or a set of modulated Walsh functions. The choice of the kind of signal used in the library will vary based on the characteristics of the media in which the signals will be used. Characteristics of interest may include the available bandwidth and/or power levels and whether the media is dominated by noise, interference or multipath characteristics.

Overview of Arbitration

The signals in the library are ranked relative to each other. During arbitration, a node compares the rank of its associated signal with the ranks of the signals associated with the other nodes seeking access. If a node's signal has the highest rank, the node takes access to the medium for that frame's payload transmission portion (103). Using a tone library as a simple example as shown in (104), the tones might be ranked by order of frequency with a higher frequency corresponding to a higher rank (105). A node selects the signal with which the node is to be associated for this arbitration and generates the signal for all other nodes in the network to detect in arbitration preamble (101). As shown in FIG. 2, the node then pauses transmission briefly (106, 201) at (a) pseudo-random time(s) during the arbitration preamble to listen for the tones being broadcast by the other nodes and notes all tones that are detected. The purpose of the pseudo-random pause is to minimize the probability that one node will not detect another node in the case where they are exactly commensurate (i.e., both are using the same pause functions and either did not detect the other). This is referred to a “mutual failure to detect” (MFD). This principal can easily be extended to introduce multiple random pauses to further reduce the likelihood of MFD with a logical extension of choosing pauses pseudo-randomly or selecting pseudo-randomly from a library of pause functions that are not unlike Walsh functions, with the understanding that by increasing the pause variation by increasing the preamble time or repeating the library selection multiple times (each time at random) the probability of MFD can be made to approach zero for any particular node of the network.

In broadcast distribution echo portion (102), each node rebroadcasts all of the tones it detected during arbitration preamble (101) along with the tone broadcast by the node in the arbitration preamble. All nodes then pseudo-randomly pause (108, 202) using any of the techniques described previously for the arbitration preamble to listen to the broadcast tones. Each node thus obtains a list of all the tones that are associated with the nodes seeking access. Each node then compares the tone that it broadcast in the arbitration preamble with the tones in the list of tones associated with the nodes seeking access. If the tone broadcast by the node in the arbitration preamble has the highest ranking, the node determines that it has access and proceeds to broadcast its payload in payload portion (103) of the frame, as shown at (109).

A node that is not currently associated with a signal from the library and wants to broadcast a message simply listens to the signals broadcast at broadcast distribution echo (102), selects a free signal, broadcasts it during arbitration preamble (101), and then proceeds just like any other node. The manner in which such a node determines which signal to select will be explained in detail later.

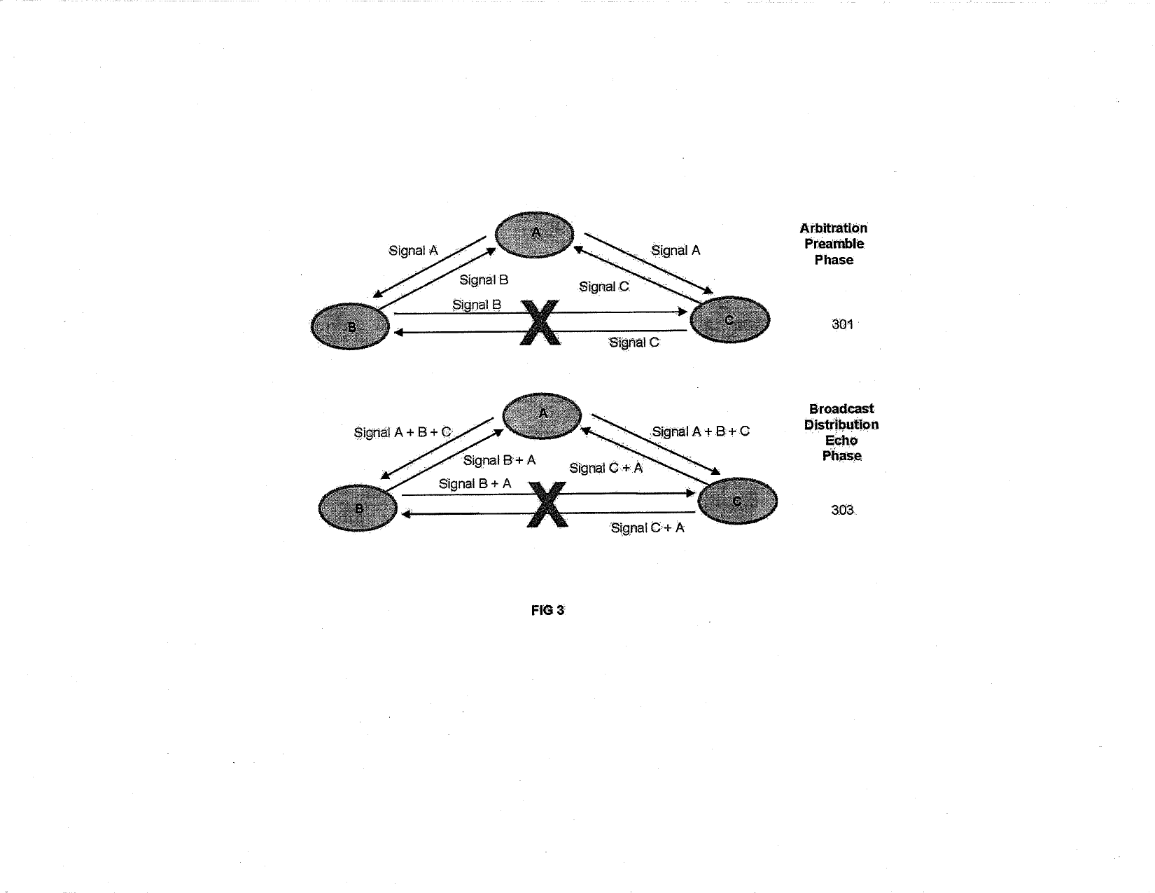

Broadcast distribution portion (102) provides a solution to the hidden terminal problem which is characteristic of open media. Absent that problem, a node could simply use list which the node obtained during arbitration preamble (101) to determine whether it has access. However, as shown at (301) in FIG. 3, a node ‘A’ situated between nodes ‘B’ and ‘C’ can detect signals from either of these nodes but ‘B’ and ‘C’ cannot detect signals from each other during arbitration preamble (101) due to lack of proximity When nodes A, B, and C broadcast their own signals and the ones they have heard from the other nodes in broadcast distribution echo portion (102), A will broadcast a list of signals that contains signals for nodes A, B, and C, and in listening to A's list, B will become aware of C and vice-versa, as shown at (303), and each node can determine the rank of its signal relative to the signals associated with all of the nodes seeking access.

Signal Selection

In order for each node to gain timely access to the broadcast medium, the nodes that are seeking access must select signals for broadcast in each arbitration preamble (101) such that the rank of a signal associated with a node that is seeking access but has not yet received it increases with each arbitration until the node receives access while the rank of a signal associated with a node that has had access but wants it again will decrease. There are two parts to this process:
A node that broadcast its signal in the preceding arbitration preamble (101) but was not granted access and still desires it selects the signal from the library which ranks next highest to the one it broadcast in the preceding arbitration preamble (101) and broadcasts that signal in the next arbitration preamble (101).
A node that has been granted access and again wants access will decrease its chances for subsequent access by associating itself with the signal in the library which ranks next highest to the highest ranking signal that was not broadcast in broadcast distribution echo (102) and broadcasting that signal in the next arbitration preamble (101). The next highest is selected because the node that used it during the last arbitration preamble has itself selected the next highest after that, as just described.

The above rules for selecting signals orders the nodes into a virtual queue in which nodes which have not yet broadcast move up until they reach the queue's head and broadcast and if they continue to want to broadcast, move to the tail of the virtual queue.

A newly entering node will always select the highest ranking unused signal which was not present in broadcast distribution echo (102) in the immediately preceding frame This is critical because it is this mechanism that creates the queue in the first place. The first node entering the network finds no activity and therefore selects the highest ranking signal in the library. In the absence of any other nodes, it will broadcast on every frame because it will select the highest ranking signal free signal in each broadcast distribution echo portion (102). Until another node wishes to broadcast, that signal will always be the highest ranking signal in the library. When a second node wishes to broadcast as well, it will select the next highest ranking free signal revealed by broadcast distribution echo portion (102) belonging to the current frame. In the next frame, the first node will still have the highest priority and will broadcast, but after broadcasting, the first node will select the first free signal revealed by the next frame's broadcast distribution echo, which now includes the signal selected by the second node. That signal which ranks one less than the signal selected by the second node for the following frame. In that frame, the second node will broadcast. In the succeeding frame, the second node will select the first free signal and the first node will select the signal which the first node had in the preceding frame, and thus the two nodes will broadcast alternately. The same process repeats for nodes 3 to N (where N is the number of signals in the library). This mechanism enables access to diminish gracefully and inversely to the number of nodes. For example a single node broadcasts on every frame; two nodes will alternate every other frame and; three nodes every third frame. This process continues until the number of nodes reaches N−1 and guarantees that all nodes will broadcast regularly and evenly. The arbitration scheme achieves the maximum uniform transport efficiency because the system always converges to a state in which each node transmits at a rate inversely proportional to the number of nodes and no frames go unused.

As will be explained in detail below, more than one node may select the same signal in a frame. In the following, such an occurrence is termed a signal conflict between the nodes that have selected the same signal. An important benefit of the queueing mechanism of the preferred embodiment is that it forces nodes which have selected conflicting signals to select signals that do not conflict and does so in a way that causes the signals selected by the nodes to converge such that there are no gaps between the selected signals.

Managing Conflicts in Signal Selection

In the signal selection algorithm described above, a node which is not yet part of the queue and wishes to obtain access to the medium selects the second highest ranking free signal. This node will be termed in the following the joining node. The joining node selects the second highest ranking free signal on the basis of the list of signals which the joining node hears in broadcast distribution echo (102). If more than one node attempts to join during a given frame, all of the joining nodes will hear the same list of signals and each of the joining nodes will select the same signal as the second highest signal, resulting in conflicts between the signals associated with the nodes.

The above conflict problem is partially solved in that the nodes themselves can detect that more than one node is broadcasting the signal the node has selected in arbitration preamble (101). A node that detects that another node has selected the same signal can respond by randomly selecting another signal from the available free signals and can broadcast the randomly selected signal in broadcast distribution echo 102. If the conflict persists, the node can again randomly select a signal and can continue to do so until there are no longer any conflicts. This mechanism ensures that the joining nodes have sorted out their positions in the virtual queue before reaching its head and therefore prevents collisions from occurring when the payload is broadcast.

Dealing with the Hidden Terminal Problem in Signal Selection

There however remains the case of the hidden terminal problem. When the problem occurs, B and C (and perhaps other nodes) cannot detect each other. In this case, two or more nodes that are in an MFD situation relative to each other can select the same signal when they join the queue and continue to increment their respective conflicting signals. When the nodes reach the head of the queue simultaneously, they will transmit simultaneously in the protocol's payload frame and the resulting collision will render the transmitted messages unreadable. Having transmitted, all the nodes will return to the end of the queue and again select the same signal, which they will again increment until they reach the head and so on over and over again.

To solve both the problem of signal selection when there are hidden terminals and the general problem of resolving conflicting signals, the preferred embodiment does the following:
it designates a subset of the signals in the signal library as a pre-transmit staging set.
it designates a signal that does not belong to the pre-transmit staging set as a queue head signal. When a node has selected the queue head signal, the node is at the head of the queue.

The nodes in the preferred embodiment select signals and transmit according to the following rules:
1. When a node joins the queue, it listens to broadcast distribution echo (102) in the current frame and on the basis of what it hears, selects the signal that will be the second highest free signal in the next frame.
2. When a node has selected a signal other than the queue head signal or a signal from the pre-transmit staging set, the node selects the next highest signal in the library in each frame.
3. When the node has selected the queue head signal in a frame, the node randomly selects one of the signals in the pre-transmit staging set in the next frame.
4. If the signal selected from the pre-transmit staging set is the highest ranking signal in broadcast distribution echo (102), the node transmits in the frame's payload (103) and selects the signal that will be the highest-ranking free signal in the next frame.
5. If the signal selected from the pre-transmit staging set is not the highest ranking in broadcast distribution echo (102), the node randomly selects a signal that will be free in the next frame.

A corollary of these rules is that no messages are transmitted in frames in which no node selects a signal from the pre-transmit staging set. A further corollary is that signal conflicts between nodes are resolved when the nodes increment the conflicting signal until it becomes the queue head signal and the nodes select signals from the pre-transmit staging set in the next frame. There will be a very high probability that the signals selected by these nodes for the next frame will all be different. Finally, the gaps between signals selected by nodes which are produced by step (4) tend to disappear because nodes that broadcast in a frame always select the signal that will be the highest free signal in the next frame. The tendency of the queue to converge is further increased by the fact that when nodes enter the queue, they select the second-highest-ranking free signal.

For example, in a library of 64 signals, 4 are designated as the pre-transmit staging set (112). In this case the 4 signals with the highest ranks are chosen. The next signal, whose rank is 60, is designated as the queue head signal. When a node selects signal 60 in the current frame, it randomly selects from 61 to 64 in the next frame and if the selected signal has the highest rank of the signals which the node hears in broadcast distribution echo (102), the node will transmit in the next frame's payload portion (103).

The set of signals from which a node that has a conflicting signal and is not selected for transmission randomly selects a signal is termed in the following the reselect set. The size of the reselect set and the rankings of the signals chosen for the set can be based on factors such as the number of occurrences of nodes with conflicting signals and minimization of the delay in access for the node that had to select a signal from the set. For example, the reselect set may be made up of a small number of free signals below the lowest-ranking signal currently associated with a node in the queue). In this case the tradeoff is increasing the probability of subsequent collisions as the reselect set is reduced versus the time it takes for the node which selected a signal from the reselect set to again work its way up to the top of the queue should the node initially select a low ranking signal. However, each node can determine its own reselect set. For example, the selection of the set may depend on the importance of the message. The randomness of the selection and fact that each node selects the signal it will use to determine its priority from its own reselection set minimizes the risk of further conflict with regard to signals between the previously conflicting nodes. If there is no further conflict, the node is now synchronized with regard to its signals with all of the other nodes and there will therefore be no further conflict when the node broadcasts and again returns to the end of the queue.

However, in a modest percentage of cases there will continue to be conflicts (in this example a 1 in 4 chance) that two nodes with conflicting signals will select the same pre-transmit staging signal and, both transmit, and the transmissions will collide. Having done so, these signals will in turn simultaneously select the highest-ranking free signal and then move up the queue until they reach the pre-transmit stage wherein they will again select at random. With each cycle through the queue, the probability that the signals will continue to conflict diminishes geometrically until one or the other eventually selects a non-conflicting signal and transmits without collision. In the above example, nodes with conflicting signals will typically make 2 or 3 passes before synchronizing to the queue.

Further Protocol Refinements

Refinements to the Signal Library

The signals in the signal library may be chosen such that there is more separation between higher ranking signals than between lower ranking signals. Using the tone library example, it may be advantageous to order the signals with increasing separation as the signal's rank increases (113). The important feature is that as the nodes rise in the queue and select higher ranking signals, the signals become as distinct as possible to ensure that the nodes can better distinguish them when they are broadcast, whereas for low ranking signals it is not as important to distinguish them because the nodes have to rise in the queue before they are broadcast. Related is the notion of introducing specifically crafted correction signals in the preamble that enable a receiving node to calibrate the signal to compensate for media perturbations such as Doppler shift.

Yet another refinement is to note that it is not necessary to use the same signal library for both the arbitration preamble and the subsequent broadcast distribution. For example, the arbitration preamble might use the tone library as each node only proffers a single tone. However in the subsequent broadcast distribution all of the tones are then rebroadcast, which significantly increases the likelihood that there will be an interference, which in an open RF network would be tantamount to a selective fade because of the differences in phases between the same tones. Instead it is possible to use a different signal set in broadcast distribution echo portion 102 which corresponds 1:1 to the signals in the tone library set but has better interference properties such as being more immune to selective fading and thereby ensuring detection even when there is a conflict among the signals selected by the nodes. An example would be to substitute a code division waveform set for the tone library in portion 102. For example each code waveform in the replacement signal library can have any number of phases and therefore selection of a phase at random by a node vastly diminishes the probability that two or more nodes will select both the same code waveform library signal and the same phase.

Scalability of the Protocol

The protocol is indefinitely scalable by simply increasing the size of the signal library. Doing so results in loss of bandwidth only to the extent that the arbitration portions of the frame grow in size relative to the payload portion. Of course, the more nodes are in the queue, the less bandwidth each node will receive. Using the simple tone library as an example, increasing the duration of the arbitration portions of the frame allows more tones (which are necessarily closer together in frequency as the bandwidth of the media is fixed) because the increase in time allows the nodes to perform commensurately finer detection.

Uses of Messages for Purposes Other than Transmitting Ephemeral Information

The YAP places no restrictions whatever on the contents of the messages which a node sends in payload 103. Consequently, nodes can broadcast messages to other nodes which contain any information of interest to the other nodes. For example, the broadcast information can contain additional information that allows the members of the network to share information regarding other communications links. A node can use the YAP to identify voice radio channels on which the node is operating and thereby allow the users at another node to identify a channel which should be used to communicate with a user at the node which sent the message. Another example is using the YAP to share routing information among nodes so that secondary media can use addressing mechanisms to effect ad-hoc routing among the nodes.

In general, a node can use the YAP to communicate with another node in any manner which takes into account the fact that the protocol does not guarantee that a message sent using the protocol will reach its destination.

Another Example of Arbitration Based on Priorities in an Ad Hoc Network

While the ranked signals and virtual queues to perform priority-based arbitration in nodes of an ad-hoc network offer a good example of the advantages of priority-based arbitration in ad hoc networks, priority-based arbitration can be used in any situation in which nodes are competing for broadcast access to the ad hoc network. For example, if a slotted protocol like RR Aloha is used in a situation where there are more nodes which desire to broadcast than there are slots in a frame, a node can use priority-based arbitration to determine whether the node should broadcast in a slot in the frame. One technique for doing this is to have the nodes assign priorities to the messages they wish to broadcast in a frame. During an arbitration preamble to the frame, each node that has a slot in the frame broadcasts the priority of the message that it wishes to broadcast and the slot it is intending to broadcast on. If a node has a message with a higher priority than the message which another node wishes to broadcast in the slot, the node with the message that has the higher priority provokes a collision with the other node in the slot. Based on the higher priority of the first node's message, the other node responds to the collision by yielding the slot to the first node.

### CONCLUSION

The foregoing Detailed Description has set forth to those skilled in the relevant technologies how to implement the YAP node arbitrated media access control protocol disclosed herein and has further disclosed the best mode known to the inventor of making and using the YAP. It will be immediately apparent to those skilled in the relevant technologies that many other applications may be made of the techniques disclosed herein and that there are many other possible implementations of those techniques. For example, in the preferred embodiment, what is arbitrated is broadcast access to a medium; however, the disclosed techniques could be employed to arbitrate in any situation in which only one node at a time may perform an action. The technique of using signals from a library known to each node to associate nodes with a queue can be used to associate nodes with a set that is formed for any purpose and the method by which a node joins the set can be used by a node to join any such set. If the signals are used simply to associate nodes with a set, the signals need not be ranked. Signals that are used to associate nodes with a queue must be ranked, but any form of ranking may be employed. Many forms of queue management other than the ones disclosed herein are also possible. The only requirement is that the broadcast of the signals associated with the nodes gives each node the information the node needs to select its next signal. Since these and many other variations on and applications of the techniques disclosed herein are possible, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A method of joining a set of nodes in an ad hoc network of nodes, each node in the network operating in an open communications medium which is shared with the other nodes and having access to a single source of time information,
the method comprising the steps performed in a joining node which has access to the single source of time information of:
in a first interval of time which the joining node determines using the single source of time information, receiving a set of signals belonging to a library thereof, the set of signals being broadcast by the nodes in the set and the library of signals being known to the joining node;
selecting a signal from the library which is not in the broadcast set;
in a second interval of time which the joining node determines using the single source of time information, broadcasting the selected signal and detecting signals from the library, the detected signals being broadcast individually by the nodes of the network; and
in a next first interval of time, broadcasting the selected signal and the detected signals.

2. A method of arbitrating access among a set of nodes to a communications medium which is shared among the nodes, each node having access to a single source of time information and being associated with a signal belonging to a library thereof, the signals being ranked in the library and the library being known to each node,
the method comprising the steps performed in a node of the set of:
in a first interval of time which the node of the set determines using the single source of time information, receiving a set of signals belonging to a library thereof, the signals in the set being associated with the nodes of the set and the set of signals being broadcast by the nodes in the set t;
determining the rank of the signal associated with the node of the set in the broadcast set of signals;
if the associated signal has the highest rank, accessing the shared communications medium during a second interval of time which node of the set determines using the single source of time information; and
otherwise not accessing the shared communications medium during the second interval of time.

3. A method of forming a queue of nodes belonging to an ad-hoc broadcast network, the queue having a head node which performs an action and each node having a copy of a library of ranked signals, all of the nodes having access to a single source of time information, and nodes in the queue being associated with signals in the library,
the method comprising steps performed in each node of the queue during repeated first intervals of time, the repeated first interval of time being determined by each node using the single source of time information and the steps comprising:
in a node which is in the queue, broadcasting the signals associated with the nodes in the queue during each repeated first interval of time;
in a node which is joining the queue, listening to the signals broadcast in a current first interval of time to determine a signal which is not currently associated with a node in the queue and associating that signal with the joining node;
in a node which is in the queue, listening to the signals broadcast in the current repeated first interval of time to determine whether the node is the head node, the head node being the node whose associated signal has the highest rank in the broadcast signals;
if the node is the head node, performing the action in a repeated second interval of time which each node determines using the single source of time information and ending the association between the node and the highest ranked signal; and
otherwise associating the node with a higher ranked signal in the library before broadcasting the signals associated with the nodes during the next repeated first interval of time.
